(19) United States
(12) Patent Application Publication
(10) Pub. No.: US 2013/0191182 A1
(43) Pub. Date: Jul. 25, 2013

(54) WORK AND QUALITY MANAGEMENT SYSTEM, DEVICE AND METHOD

(71) Applicants: Sek Min Foo, Singapore (SG); Hee Kwang Steve Lee, Singapore (SG); Chi Wing Joe Chiu, Singapore (SG)

(72) Inventors: Sek Min Foo, Singapore (SG); Hee Kwang Steve Lee, Singapore (SG); Chi Wing Joe Chiu, Singapore (SG)

(73) Assignee: CHANGI AIRPORT GROUP (SINGAPORE) PTE. LTD., Singapore (SG)

(21) Appl. No.: 13/825,872

(22) PCT Filed: Sep. 16, 2011
(86) PCT No.: PCT/IB2011/054044

§ 371 Date: Mar. 25, 2013

Related U.S. Application Data
(60) Provisional application No. 61/386,988, filed on Sep. 27, 2010.
(60) Provisional application No. 61/387,461, filed on Sep. 28, 2010.

(51) Int. Cl. G06Q 30/02

(52) U.S. Cl. CPC G06Q 30/0201
USPC 705/7.32

(57) ABSTRACT

The application provides a system for supporting facilities management services. The system comprises at least one client terminal computer, an Inspection server computer, and at least one mobile computing device. In particular, the client terminal computer comprises a display device, at least one corresponding tactile input device, and a client wireless communication module. The Inspection server computer comprises a server wireless communication module for communicating with the client terminal computer, a server wireless phone module for communicating with the mobile computing device, and a pre-determined set of inspection data lists. The system provides a user feedback data acquisition mode, an alert mode, and a site inspection mode.

### FIELD OF THE INVENTION

This application relates to a system, to a device, and to a method of work and to a quality management system.

### BACKGROUND OF THE INVENTION

Outsourcing of labor-intensive tasks is one way to reduce costs and to improve the quality in many business areas. When outsourcing customer sensitive services, such as the provision of public toilets, it is crucial to control carefully the quality of the services provided in order to achieve an acceptable result for reasonable costs.

Customer satisfaction and attitude research surveys are common. Most surveys receive customer feedback either by requiring a customer to provide written responses to a survey questionnaire or by requiring the customer to respond orally to questions asked during a telephonic survey. Questionnaires or surveys requiring written responses are sent to a central location where the responses are read, transcribed, sorted, and manually forwarded to the relevant company.

There are computer aided customer satisfaction systems available but in practice, they are seldom used.

It is an object of the application to provide an improved feedback system.

### BRIEF DESCRIPTION OF THE DRAWINGS

FIG. 1 illustrates an embodiment of an integrated feedback management system,

FIG. 2 illustrates a first level service feedback on a display of a touch screen of the feedback management system of FIG. 1,

FIG. 3 illustrates a second level service feedback on the display of the touch screen of the feedback management system of FIG. 1,

FIG. 4 illustrates an alert on a display of a smart phone of the feedback management system of FIG. 1,

FIG. 5 illustrates a report in respond to the alert of FIG. 4,

FIG. 6 illustrates a routine inspection checklist on the smart phone of the feedback management system of FIG. 1,

FIG. 7 illustrates a report for the routine inspection checklist of FIG. 6,

FIG. 8 illustrates another embodiment of an integrated feedback management system,

FIG. 9 illustrates a state diagram for a two-level service feedback for the feedback management system of FIG. 8,

FIG. 10 illustrates a state diagram of an example of the service feedback of FIG. 9,

FIG. 11 illustrates a further embodiment of the integrated feedback management system, and

FIG. 12 illustrates another embodiment of the integrated feedback management system, which is a variation of the integrated feedback management system of FIG. 11.

### DESCRIPTION OF THE PREFERRED EMBODIMENTS

In the following description, details are provided to describe embodiments of the application. It shall be apparent to one skilled in the art, however, that the embodiments may be practiced without such details.

Some parts of the embodiments, which are shown in the Figs. below, have similar parts. The similar parts may have the same names or similar part numbers with a prime symbol. The description of such similar parts also applies by reference to other similar parts, where appropriate, thereby reducing repetition of text without limiting the disclosure.

In the description below, the term customers refers to external customers, such as passengers and airport users, although the term can also refer to internal customers. Services provided by one department of a business entity to another department of the same business entity can be viewed as services provided by one department to its internal customer.

The passengers and airport users can receive services from frontline staff of an airport terminal and also receive services from facilities, such as a toilet, of the airport terminal. The term airport and the term airport terminal are used interchangeably. The airport terminal facilitates boarding of passengers onto an aircraft as well as disembarking of passengers from the aircraft.

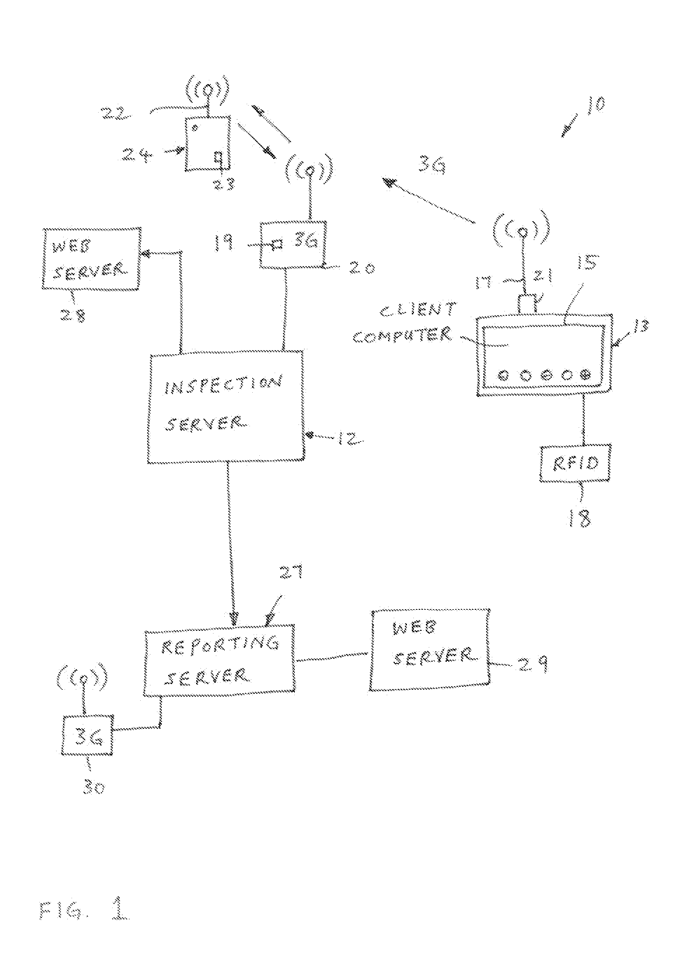

FIG. 1 shows one embodiment of an integrated feedback management system 10.

The feedback management system 10 includes an inspection server 12 and a plurality of front-end client computers 13. The inspection server 12 is communicatively connected to the client computers 13. The term server refers to a main computer that is used to control other computers or to communicate with other computers, and for storing data which has been provided by other computers. A server can also evaluate and manipulate this data.

The client computer 13 includes a touch screen 15. The touch screen 15 is also known as a touch point terminal. The touch screen 15 is electrically connected to an antenna 17 via a wireless GSM (Global System for Mobile Communications) communication module 21 and to an RFID (radio frequency identifier) card reader 18.

The inspection server 12 has a wireless 3G (Third Generation) modem 20 that is communicatively connected to the client computer antenna 17 and to an antenna 22 of a smart phone 24 using SMS (Short Message Service) technology. The smart phone 24 refers to a mobile phone with a certain computing ability. The smart phone 24 has a built-in camera 25. The inspection server 12 is also connected to other servers or computers 28 via the Internet and to a reporting server 27. The computer 28 comprises a web server that acts as a software application.

The 3G modem 20 and the smart phone 24 each have one wireless GSM communication module 19 and 23, respectively, for communicating with each other. The computer antenna 17 is also connected to the wireless GSM communication module 21 of the client computer 13.

The reporting server 27 is connected to other servers or computers 29 via the Internet. The reporting server 27 also has a wireless 3G modem 30. The computer 29 comprises a web server that acts as a software application.

In a general sense, for communicating with each other, the inspection server 12 and the smart phone 24 can have wireless network communication modules, WLAN (Wireless Local Area Network) communication modules, or other wireless communication modules, instead of the GSM communication modules. The WLAN communication modules uses Wi-Fi communication protocol as published by the Wi-Fi Alliance.

Similarly, the client computer 13 and the inspection server 12 can also have GSM communication modules, WLAN communication modules, or other wireless communication modules for communicating with each other. While the RFID card reader 18 is one form of a card reader, other forms of the card reader are also possible.

In use, the integrated feedback management system 10 is used to obtain immediate service feedbacks from customers, e.g. in an airport. The immediate feedback refers to a feedback from a user wherein the service feedback is provided soon or quickly after the user has received the service. The service feedback is then used to transform or to improve services provided by a workforce of the airport.

Referring to the client computer 13, this device serves as an immediate or instant feedback device.

The feedback device can be installed at check-in counters, at immigration and information counters, at retail counters, as well as at food and beverage outlets. The feedback device can also be installed at other areas, including custom inspection and refund counters, and transfer counters. Being installed at these areas, the feedback device is easily accessed by passengers at these areas to register their satisfaction levels immediately after receiving their service from frontline staffs at these areas.

The touch screen 15 is used for displaying service satisfaction ratings to customers after the customers have received services. The customers can indicate their satisfaction service ratings using multiple tactile sensors of the touch screen 15. A tactile sensor is sensitive to pre-determined selective motion of a user such as a touch, a force, or a pressure.

The client computer antenna 17 is used by the wireless communication module 21 of the client computer 13 to transmit the received satisfaction service ratings to the inspection server 12. The ratings are transmitted in an online and electronic manner to achieve a rapid feedback.

The service staffs use the card reader 18 for clearing or for resetting the recorded service ratings that the client computer 13 has received and has recorded. This clearing is usually done after the service staffs have responded to anomaly in the service ratings.

Referring to the inspection server 12, the 3G modem 20 has the wireless communication module 19 that is used for receiving the satisfaction service ratings transmitted by the client computer 13. The 3G modem 20 is also used for transmitting the said ratings to a memory unit of the inspection server 12 for storing. The memory unit is not shown in FIG. 1.

The inspection server 12 is used to identify any unsatisfactory service rating in an automated manner and to send an alert or maintenance request regarding the unsatisfactory service rating to the smart phone 24 via the 3G modem 20 in an automated and electronic manner. The alert is transmitted using SMS technology to push the alert to the smart phone 24.

The smart phone 24 is intended to be carried by a supervisor of the service staffs who are responsible for the areas covered by the client computers 13. After receiving the alert, the supervisor may respond to the alert. The response can include investigating the alert and initiating actions to correct the alert.

The supervisor may not respond right away in certain situations. When the alert is regarding certain shops, like restaurants, the supervisor may need to respond only after several alerts are received such that the several alerts form a consistent trend verifying that the alerts are valid. On the other hand, in the case of washroom facilities, the supervisor should respond to the washroom alert as soon as possible and not wait for several alerts confirming the validity of the alerts.

The supervisor may also generate an alert report using the smart phone 24. The report can include photographs that are taken using the smart phone camera 24. The smart phone 24 is also used to transmit the alert response report to the inspection server 12, where they are stored for evaluation purposes.

The smart phone 24 with its built-in camera is intended for use by the supervisor to scan a 2D (two dimensional) barcode. The 2D barcode has vertical and horizontal components that are used to hold location information. Although the embodiment uses 2D barcode, other types of barcode can also be used.

In an embodiment not shown here, several smart phones are provided. Each smart phone is dedicated to a predetermined alert message, such that an alert is pushed to the respective smart phone. There may be one smart phone for a plumber, one for a toilet paper and hand towel supplier, one for an electrician, etc.

The smart phones can be produced by different manufacturers and be provided as different models. The alert is usually sent to the smart phone held by a supervisor, who is in charge of the work shift.

The 2D barcode is location based, which means that each location has a unique 2D barcode.

The 2D barcode is fixed at certain locations and it is intended to be scanned before the supervisor starts checking or inspecting these locations. The barcode information is later used to match a data message from the smart phone with a respective data base entry for the location. The scanning of the barcode is also used to verify that the supervisor is present at the particular location and not at other locations.

The smart phone 24 is used for attaching the location information to the alert response report or to other types of report.

The smart phone 24 is also used for receiving an inspection checklist from a set of predetermined checklists that are kept at the inspection server 12. The inspection checklist is intended for use by the supervisor to remind or to inform the supervisor about inspection tasks that the supervisor need to do at predetermined locations.

The checklists are content-wise pre-determined and there is a relationship between the rank or capability of the supervisor and the content of the checklist.

After using the inspection checklist to check or to inspect certain locations, the supervisor uses the smart phone 24 to generate a report regarding the checking. The report can include photographs of the location that are taken using the smart phone camera 25 and it includes the location information obtained from the barcode.

The supervisors can also access the received service ratings that are stored in the inspection server 12 as well as the alert response report for monitoring purpose.

The inspection server 12 is also used for transmitting the received service ratings and the alert response report to the reporting server 27. In one example, the service ratings and alerts are collected and are transmitted to the reporting server 27 three times a day.

Referring to the reporting server 27, this device is used for receiving the service ratings together with the alert response report. The reporting server 27 is used for generating management reports using the received service ratings. The management reports can be generated every period, which can be a week or a month. The management reports can include trend charts and other analytical graphs.

In a generic sense, the feedback management system 10 acts as a system for supporting facilities management services. The front-end client computer 13 acts as a client terminal computer. The touch screen 15 acts as a display device with a tactile input device. The antenna 17 being connected to a communication module acts as a client wireless communication module. The inspection server 12 acts as an Inspection server computer. The 3G modem 20 acts as a wireless communication module for communicating with the client terminal computer and it also acts as a server wireless phone module for communicating with the smart phone.

One method of using the integrated feedback management system 10 to response to a service report is described below. The method comprises a step of the frontline staff providing a service to a customer.

After receiving the service, the customer is able to provide immediate feedback about the service via the touch screen 15 that is located directly in the area where the service is provided. This allows the customer to provide immediate service feedback. The customer provides an indication of the service by selecting a service rating shown on the touch screen 15.

The service rating is then transmitted to the inspection server 12, which monitors the received service ratings. When the inspection server 12 detects an anomaly in the service ratings, such as a dirty waiting area, the inspection server 12 transmits an alert about the affected service to the smart phone 24.

The supervisor carrying the smart phone 24 later receives the alert and responds to the alert. The supervisor then visits the site indicated with the alert. The supervisor later scans the location barcode that is located at the site using the smart phone 24. The scanning is to verify that the supervisor is present at the particular site. The scanning obtains location information contained in the bar code, which is then stored by the smart phone 24.

After this, the supervisor conducts an inspection of the site and rectifies any found causes related to the alert. The supervisor may assign service staff or resources to rectify the reason for the alert.

The supervisor may also generate a data report about the alert using the smart phone 24. The smart phone 24 can also be used to take pictures of the site for including in the report. The smart phone 24 also attaches the received location information to the report for verifying that the supervisor is present at the said location.

The reporting server 12 receives the service rating data and the alert and with the associated data report. The reporting server 12 periodically generates management reports using the said received information. The management then uses the report or a trend report generated from the data to motivate, to reward, and to counsel their service staff as appropriate.

The method has an aspect of increasing the number of feedbacks from passengers, since the touch screen 15 is conveniently located near where the customers received the service. The increased feedbacks better reflect needs of the customers, which can be used by airport agencies or groups for improving their service. The number of passenger feedback may increase by 25 times when the integrated feedback management system 10 is used. The service feedback is also done in a real time and electronic manner, which means that the feedback is done quickly.

Besides generating analytical service report to rectify bad services, the received service ratings can be used to reward service personnel that show a good performance.

One possible implementation is for allocating bonuses, which are received by restaurants, to service personnel with good service performance. In countries, such as Singapore, restaurant customers pay a mandatory service charge that is collected by the restaurant. The restaurant owner can later allocate these service charges using the received service ratings. Service staffs with good service performance would be allocated a large part of the service charges.

The reporting server 12 can also correlate the service ratings to other information of the customers, such as their airline travelling class, which can be business or economy, spent characteristics, nationality, and gender. In this manner, the service requirements of certain groups of the customers can be derived.

In addition, the correlation can be used to validate service feedback. This is because certain service feedback may be biased by culture and may thus need to be interpreted differently for different customer groups. This validation of the service feedback serves to avoid misinterpreting the service feedback.

One method of using the integrated feedback management system 10 to manage work is described below.

The method comprises a step of the inspection server 12 generating an inspection checklist or an inspection to-do list for the supervisor of frontline service staffs.

In a generic sense, the inspection checklist serves an inspection data lists.

The inspection checklist includes items be checked or be inspected. These items reflect conditions or status of a service standard that the airport management wants to achieve. The items can be regarding conditions of a facility, like a washroom. Alternatively, the items can be regarding services provided by frontline staffs.

The inspection server 12 then sends the inspection checklist to the smart phone 24 that is assigned to the supervisor who is responsible for the respective site. After the supervisor has received the inspection checklist via the smart phone 24, the supervisor proceeds to the location indicated by the checklist.

The supervisor then scans a barcode located at the indicated location using the camera 25 of the smart phone 24 to obtain location information contained in the barcode. The smart phone 24 later stores this location information.

The supervisor then uses the checklist to inspect the location and to rectify any matters arising from the inspection. After the inspection, the supervisor may take photographs for reporting any visual defects using the smart phone camera 25. After this, the supervisor generates the inspection report using the smart phone 24. The report would include any photographs taken earlier. The smart phone 24 later sends the inspection report together with the received location information to the inspection server 12.

The method is also useful for controlling and managing quality of work or service, especially when such work is done by outsourced vendors.

In a special implementation, the client computer 13 is installed at a washroom of an airport terminal.

The airport management of this particular terminal places great emphasis on cleanliness of the washrooms. To ensure that the washrooms are clean at practically all times, the client computers 13 are installed at the washrooms.

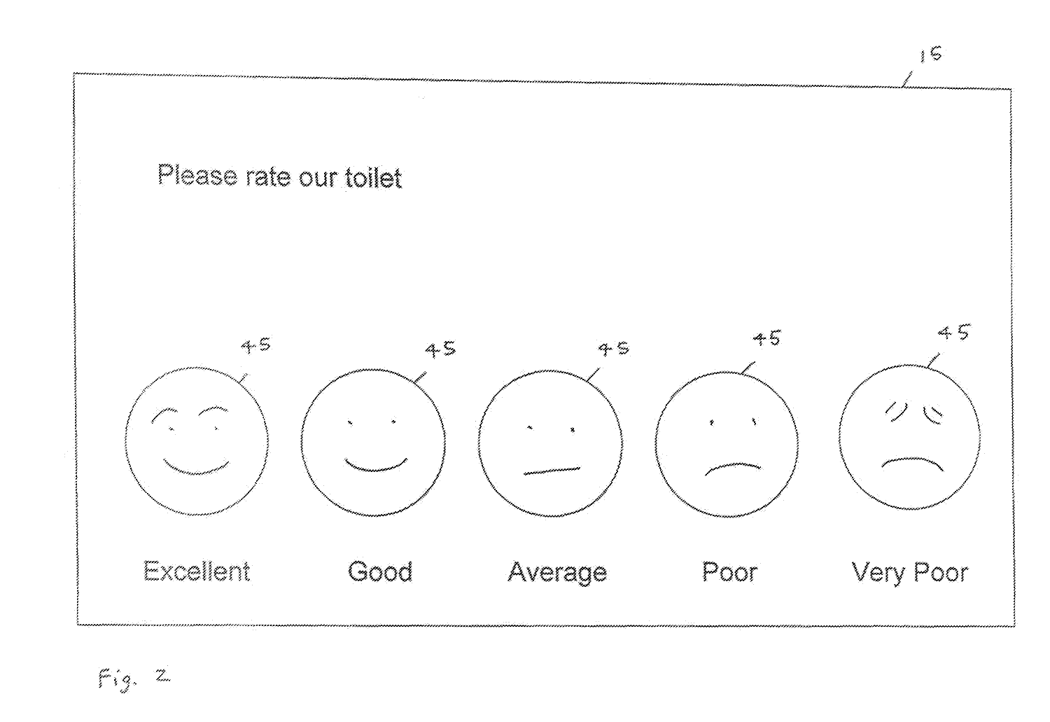

Passengers using the washrooms are enabled to rate the cleanliness of the washrooms via an interactive touch screen 15 using a five scale points of washroom satisfaction. The touch screen 15 with a set of on-screen icons 45 for rating is illustrated in FIG. 2.

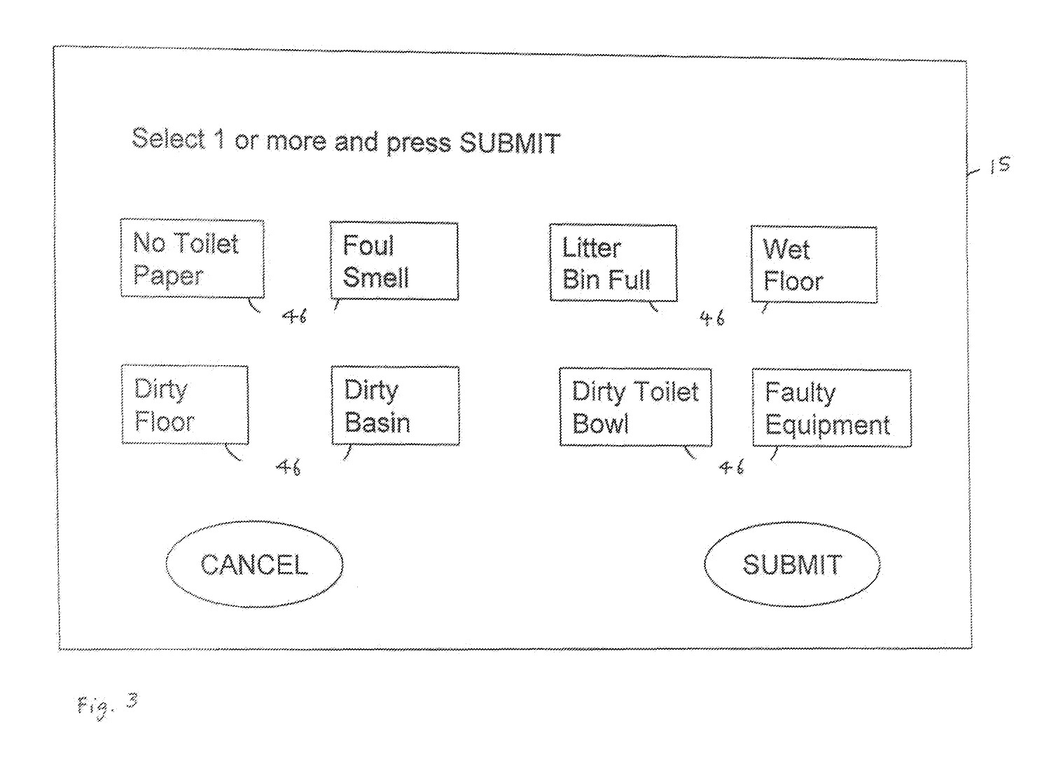

When the less satisfactory rating icon 45 is selected, the passengers are immediately prompted to indicate reasons for the selected ratings by selecting one or more other on-screen icons 46, as illustrated in FIG. 3. These on-screen icons reflect conditions of the washroom, which includes a wet floor condition, a no-toilet paper condition, or a dirty basin condition. More icons for further conditions can be easily provided.

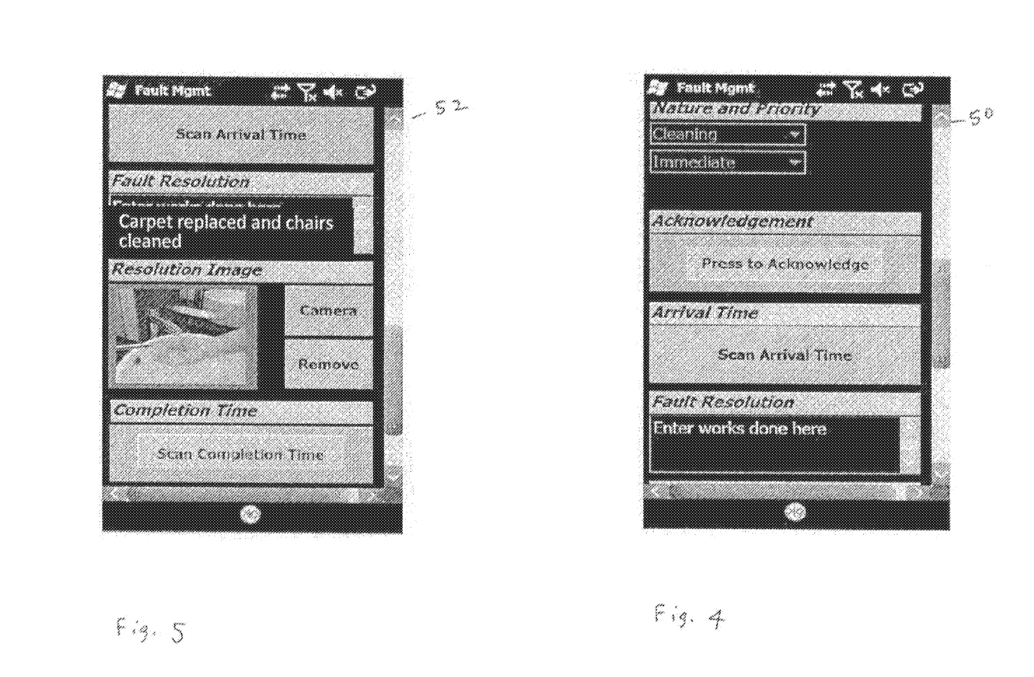

Once one or more of the poor conditions icons is selected, an alert 50 is then immediately transmitted to a smart phone 24 of a cleaning supervisor for activating necessary corrective actions. The alert is illustrated in FIG. 4.

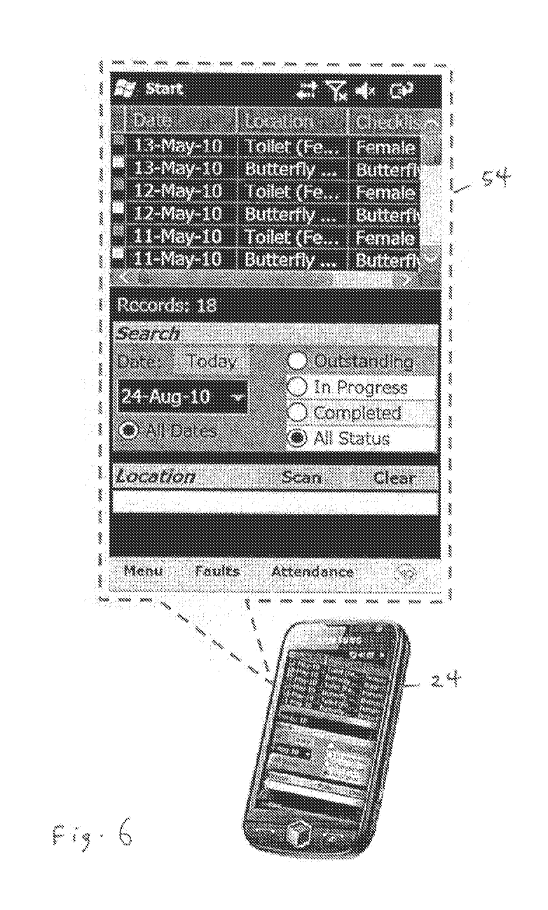

The cleaning supervisor may then visit the unsatisfactory washroom as indicated by the alert to rectify the poor condition of the washroom. The smart phone 24 is used to scan a bar code at the washroom to indicate that the supervisor is present at the washroom. The cleaning supervisor later generates a report 52 using the smart phone 24, as illustrated in FIG. 5. The smart phone 24 also attaches the washroom location information to the report 52.

The supervisor may alternatively log in to the respective client computer 13 using an appropriate RFID card. The client computer 13 then displays the respective feedback of the customer. The supervisor can then clear the respective response in the client computer 13, which in turn transmits the respective data as an alert report to the inspection server 12.

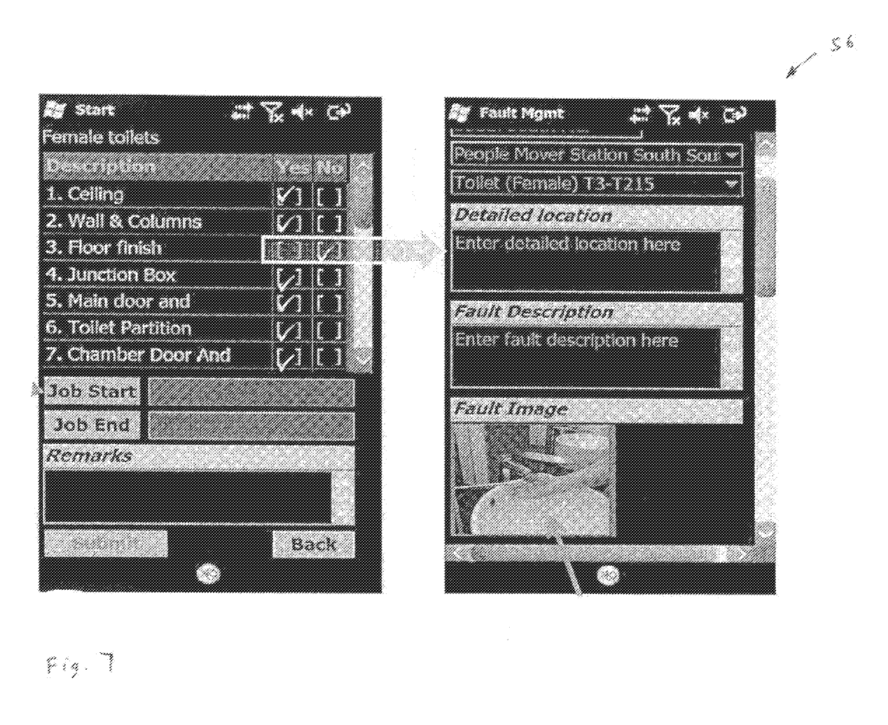

Routinely, the cleaning supervisor also receives a cleaning checklist 54 from the inspection server 12 on the smart phone 24, as illustrated in FIG. 6.

The supervisor afterward visits a location indicated by the checklist 54. The smart phone 24 is then used to scan a bar code at the indicated location to receive the location information contained in the bar code.

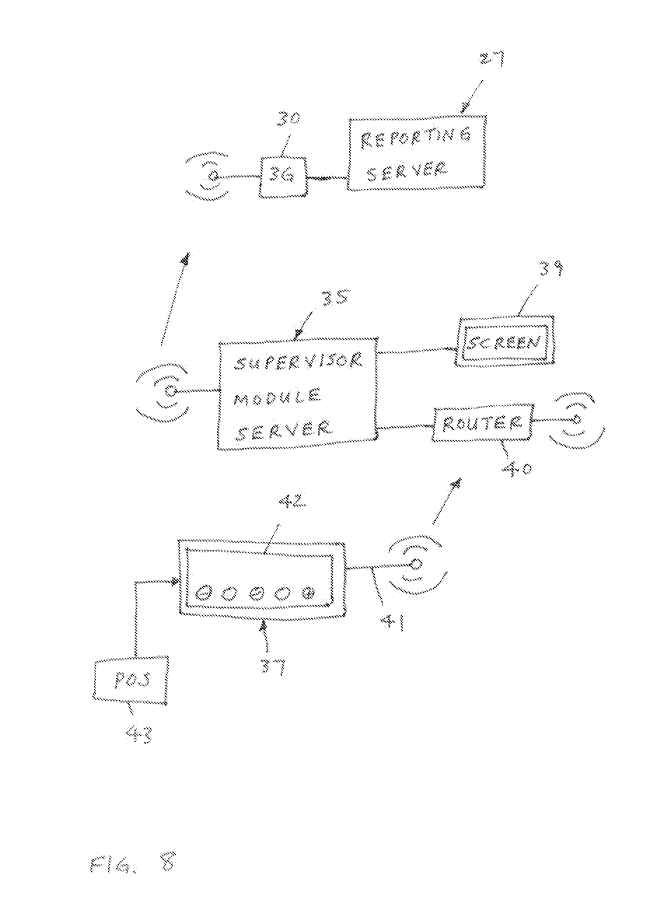

After this, the supervisor conducts an inspection as indicated by the cleaning checklist 54. The supervisor also generates a report 56 using the smart phone 24, as illustrated in FIG. 7. The smart phone 24 then attaches the received location information the report 56.

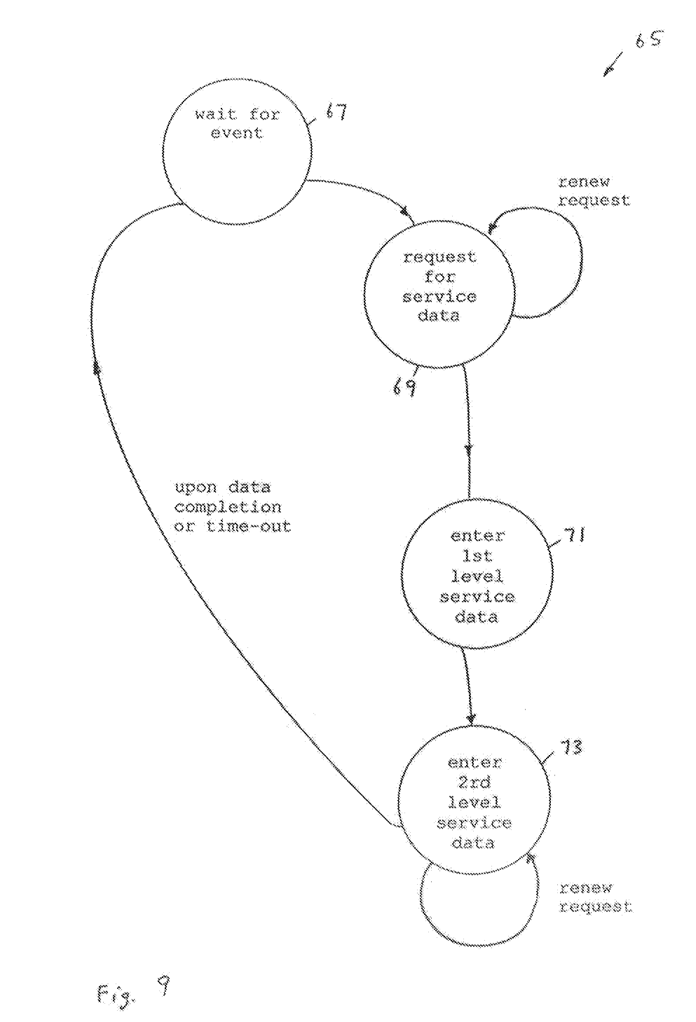

FIG. 8 shows another embodiment of the integrated feedback management system. FIG. 8 depicts an integrated feedback management system 58 that includes a supervisor module server 35 being communicatively connected to a front-end client computer 37.

The supervisor module server 35 has a supervisor screen 39 and a router 40 with a wireless access point. The router 40 is communicatively connected to the client computer 37 via the wireless access point. The supervisor module server 35 is also communicatively connected to the reporting server 27 of FIG. 1 via a wireless medium.

The client computer 37 has a WLAN (Wireless Local Area Network) antenna 41 and a touch screen 42. The client computer 37 is communicatively connected to a POS (point of sale) terminal 43.

The POS terminal 43 is located in a retail shop and is located near to the client computer 37.

In a general sense, the reporting server 27 and the supervisor module server 35 can have WLAN communication modules, GSM communication modules, or other wireless communication modules for communicating with each other.

In use, the POS terminal 43 is used in a retail outlet, such a restaurant, for accepting payment from customers.

In one implementation, the POS terminal 43 electrically triggers the client computer 37 upon scanning a first item of a purchase by a customer. The customer is then provided with a time period to provide service rating via the client computer 37. The time period extends from the scanning of the first item of the purchase to the end of the service rendered to the customer. In comparison, the client computer 37 is adapted to accept the service ratings from the customers within the time period.

In a further implementation, the POS terminal 43 electrically triggers the client computer 37 to accept service feedback after accepting the payment while the client computer 37 is used for accepting or receiving service ratings from the customers. Put differently, the customers are enabled to provide service rating via the client computer 37 immediately after receiving the service, which refers here to payment of the service.

In effect, this allows each customer to provide only one service feedback. An unhappy customer may want to exaggerate his service feedback by providing multiple service feedback. This client computer 37 together with the POS terminal 43 prevents such multiple invalid feedbacks from occurring. The client computer 37 has thus an aspect of receiving reduced invalid customer rating.

In addition, the client computer 37 has a time window in which the customer can provide the service ratings to the client computer 37. Upon completion of the time window, it is assumed that the customer does not wish to provide the service feedback. Hence the client computer 37 does not accept any service feedback upon completion of the time window. The time window is thus used to prevent others, who are not the relevant customers, from providing a service feedback. The time window also provides an aspect of reducing invalid service feedback.

The link between the service person and the client computer is provided by an external device. No other identifier is necessary. Put simply, this service control means is simple to implement.

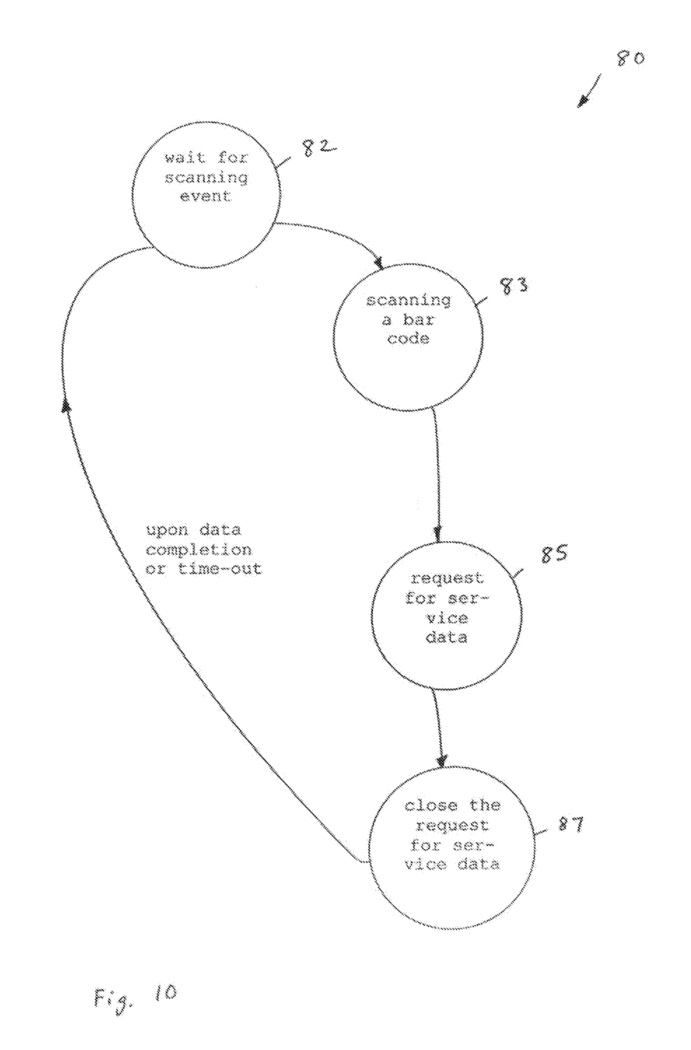

The client computer 37 can use a two level manner for service feedback. A state diagram 65 for the two level service feedback is shown in FIG. 9.

The state diagram 65 includes a state 67 of the client computer 37 waiting for completion of an event, such as bill payment. The POS terminal 43 triggers the client computer 37 when the event is completed. The client computer 37 then moves to a state 69 of requesting for service data from the customer.

After the customer accepts the request, the client computer 37 enters into a state 71 of entering a first level service data by the customer. Upon receiving the data from the customer, the client computer 37 then moves into a state 73 of prompting the customer to enter a second level service data.

The two level service data structure has an aspect of allowing the customer a structured way to provide more service information.

After this, the client computer 37 returns back to the state 67. The client computer 37 can also move back to the state 67 after waiting for a pre-determined time with the assumption that the customer does not wish to provide more data after the pre-determined time.

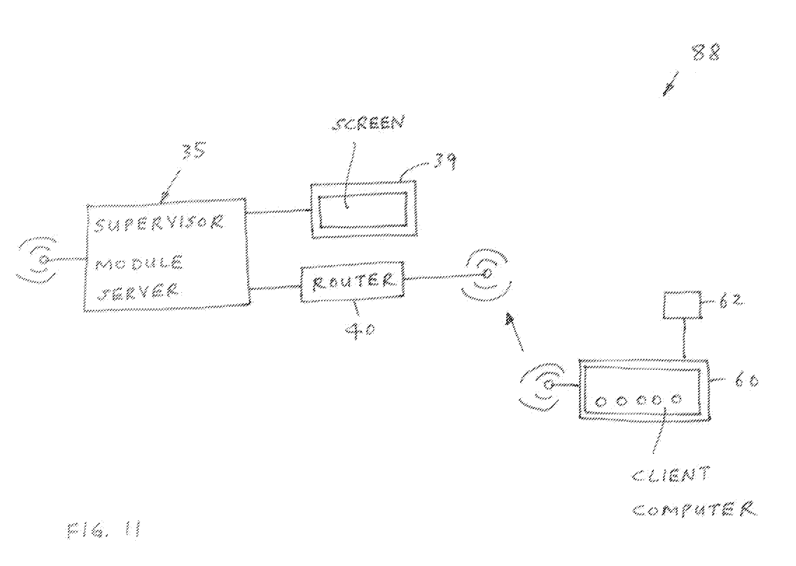

FIG. 10 shows a state diagram 80 of an example of an implementation of the service feedback of FIG. 9. In this example, a sale or counter staff is servicing a customer, who is wants to purchase one particular item or a list of items.

The state diagram 80 includes a state 82 of the client computer 37 waiting for a completion of a bar code scanning event of the first purchase item. The bar code scanning event denotes a time-point that is close to or that is at a completion of the purchase of the item.

The state 82 is followed by a state 83 of the sale staff scanning a bar code of the first item, which the customer wishes to purchase. The scanning is done using a bar code scanner that is part of a POS terminal 43.

The act of scanning triggers or initiates a state 85 of a touch screen 42 of the client computer 37, wherein the touch screen 42 displays messages to prompt the customer for providing data or inputs relating to the service that the customer has just received. The touch screen 42 is also adapted accordingly for receiving the inputs, which are in the form of touches from the customer.

This service data input occurs at an appropriate time when the customer has received the service or during the time when the customer is receiving the service from a particular counter staff. In other words, the collection of service feedback is immediate.

This is then followed by a state 87 of closing or of deactivating the service data collection. This closing of the service data collection is initiated upon completion of the input of service data from the customer or after a pre-determined waiting time. When the service data request is closed or is deactivated, the client computer 37 does not take in any further service comments or inputs from the customer.

The waiting time provides a time for the customer to provide his service comments. If no comment is received by the client computer 37 within the waiting time, the client computer 37 deems that the customer does not wish to provide the service comments and it then closes the service data collection. Leaving the service data collection activated beyond the waiting time may allow others, rather than the customer, to provide service comments. These service comments would probably not reflect the quality of service that is provided by the service provider.

In short, a predefined period or window is provided for the customer to provide his service comments. These service comments are captured in an electronic manner and can be processed immediately according to predetermined guidelines by the computer.

In summary, these features improve integrity of received service data. The received service data can then be used to direct service quality improvement in the required areas.

In a general sense, although the scanning of the bar code of the purchase denotes or signals a sale process, other steps, such as printing of a sale receipt, can also be used to signal the sale process and be used to trigger the request service data.

Other means to trigger the client computer 37 for requesting service feedback are possible. These means includes a button, which provides a service feedback request signal upon completion of a certain service task, such as payment of service. The means can also include a touch screen that allows the customer to initiate a service feedback. In certain cases, the means can refer to a motion sensor in which the motion sensor detects a presence of a customer in front of the client computer 37, wherein each customer is allowed to provide one single service feedback. The motion sensor does not only provide information about a specific and selective movement of the customer but it detects also the unspecific presence of one or more persons in front of the client computer 37. A group of customers would then only be allowed to enter one single customer feedback response. This can be useful for check-in counters, where several persons create one single business transaction that is valid for the multitude of persons.

In a general sense, the front-end client computer 37 acts as a client terminal computer. The touch screen 42 acts as a display device and with one or more corresponding tactile input device. The antenna 41 is connected to a communication module to act as a client wireless communication module for communication with a further computer device, which can be an Inspection server or a supervisor module server. The front-end client computer 37 includes a trigger port for receiving a trigger signal from the POS terminal 43.

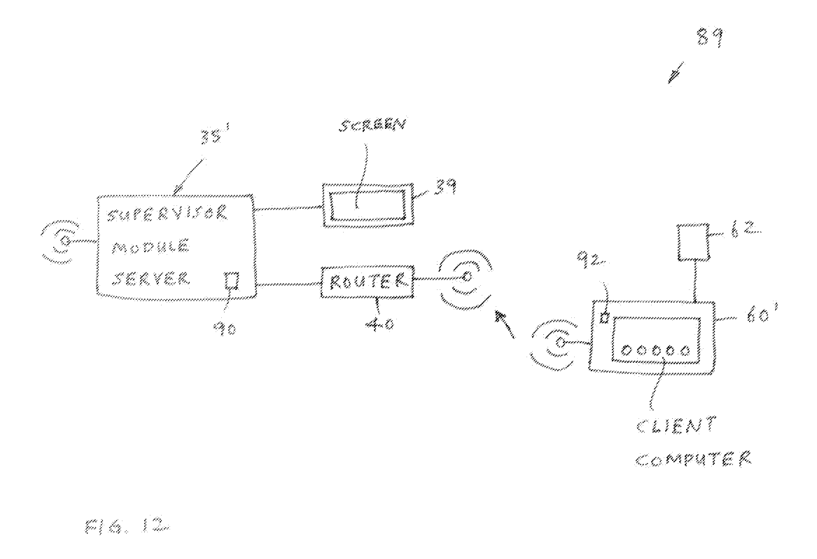

FIG. 11 shows a further embodiment of the integrated feedback management system. FIG. 11 depicts an integrated feedback management system 88 that includes the supervisor module server 35 of FIG. 8 that is communicatively connected to a client computer 60.

The supervisor module server 35 includes the router 40 with a wireless access point. The wireless access point is communicatively connected to the client computer 60. The client computer 60 includes an RFID reader 62.

In a general sense, the client computer 60 and the supervisor module server 35 can have WLAN communication modules, GSM communication modules, or other wireless communication modules for communicating with each other.

The RFID reader 62 is used to read an RF identifier of a service provider to authenticate the service provider. Upon authentication, the service provider is allowed to access information in the client computer 60.

The client computer 60 is provided for collecting customer feedback and for forwarding the customer feedback to the supervisor module server 25.

The supervisor module server 35 forwards the respective data to the inspection server 12 or to the reporting server 27.

In a general sense, the reporting server 27 and the supervisor module server 35 can have WLAN communication modules, GSM communication modules, or other wireless communication modules for communicating with each other.

FIG. 12 shows another embodiment of the integrated feedback management system. FIG. 12 depicts an integrated feedback management system 89, which is a variation of the integrated feedback management system of FIG. 11.

The feedback management system 89 includes a supervisor module server 35′ that is communicatively connected to a client computer 60′.

The supervisor module server 35 includes a server memory module 90 while the client computer 60 includes a computer memory module 92.

In use, the computer memory module 92 is used for storing data received by the client computer 60′ from a user. The data includes customer service data or customer comment data. The data in the computer memory 92 are arranged in a computer database for easy access.

These data are later transferred via communication modules over a wireless medium to the server memory module 90. The data in the server memory module 90 are arranged in a server database for easy access and are intended for processing by the supervisor module server 35′.

A user can use ODBC (Open Database Connectivity), SQL (Structured Query Language), or OLEDB (Object Linking and Embedding Database) protocols for accessing or for managing these databases.

The transfer of the data from the computer memory module 92 to the server memory module 90 usually occurs soon after the computer memory module 92 receives the said data. When the communication link between the supervisor module server 35′ and the client computer 60′ is broken or is disrupted, the data received by the client computer 60′ is not sent to the server memory module 90 and it continues to reside in the memory module 92. These data are later then sent to the server memory module 90, when the communication link is established or restored. In other words, data synchronisation between the supervisor module server 35′ and the client computer 60′ is done when the communication link is established or restored.

This feature has the advantage of allowing the feedback management system 89 to continue working during a short disruption of the communication link.

In a general sense, data can also be sent from the server memory module 90 to the computer memory module 92 via the same said mechanism.

In a further embodiment, two or more of the embodiments of FIGS. 1, 8, and 10 can be combined into one single system by linking the reporting server both to the inspection server 12 and to the reporting server 27. The embodiments of FIGS. 8 and 10 can be combined into one single system by linking the two client computers 37 and 60 to the same supervisor module server 35.

In the embodiments of the application, the phone is provided as a smart phone that supports both audio communication with other phones and data communication for transmitting data messages. While for the above applications it is not necessary that the phone 24 provides audio communication capabilities, this is helpful, because such a device is more acceptable to a user than a pure data communication phone that does not provide audio communication capabilities. The phone in general can be a mobile computing device but the quality of the services provided is improved if at least the supervisors are equipped with mobile computing devices that also provide instant audio communication capabilities without the necessity to plug in an external microphone and headphones. This can be done by providing a smart phone. It is then useful if this type of device is also used for receiving data such the alert data and for compiling and transmitting data such as the inspection data reports.

In short, the embodiments provide several capabilities or features for operating an airport.

Passengers at the airport are enabled by the embodiments to provide airport management with real-time or immediate feedback of services received by the passengers using pre-determined terminals, such as a touch-point or touchscreen terminal. Put differently, the passengers are able to provide a service feedback soon or immediately after the passengers have received the service. The embodiments also allow tracking and monitoring of these customer feedbacks. When service recovery actions are needed for responding to these customer feedbacks, these actions can also be initiated soon after receiving these customer feedbacks.

Ratings of the customer services that are rendered or that are provided by airport frontline staff can then be derived immediately and quickly. Current trends or status of services provided by business entities operating at the airport can also be known and be analysed rapidly for improving these business services. Modern technologies and novel innovations are used for delivering an end-toend or comprehensive solutions for managing the airport services. The embodiments have an aspect of ensuring high standards for services and high standards for facilities at the airport.

These embodiments are different from other airport feedback systems that receive customer feedback through various channels, such as feedback kiosks within the airport terminal, manual feedback forms, airport website, and even verbally over telephone and customer information counters. These channels have a time lapse in addressing the feedback received as much time is taken to consolidate, to disseminate, to investigate, and to reply to the customers. While these channels allow the airport staffs to identify areas where its service performance falls short, the feedback is not immediate. This also limits the opportunity for the airport staffs to turn around any unpleasant service feedback.

The application provides a system for supporting outsource facility management services to a third party. The system has a structure to allow for an online or an electronic feedback, which is quick and is immediate. This system can be used for collecting service feedback.

The system comprises at least one client terminal computer with a display device, with at least one corresponding tactile input device, and with a client wireless communication module. The tactile input device includes a touch screen, buttons, or tactile means that one must press or touch in order to provide an input.

The system also comprises an Inspection server computer with a server wireless communication module for communicating to the at least one client terminal computer, as well as with a server wireless phone module for communicating to at least one mobile computing device. The mobile computing device can include a smart phone or a wireless phone. The server wireless communication module and the server wireless phone module can be provided as one single module, which performs both functions of communication with the client terminal computer and with the mobile computing device. The Inspection server computer further comprises a pre-determined set of inspection data lists.

The system also includes one or more mobile computing devices.

In use, the system provides a user feedback data acquisition mode, an alert mode, and a site inspection mode.

By providing the dedicated site inspection mode, it is possible to make sure that service providers do not minimize or reduce their expenditures for areas that they are responsible in such a manner that causes unacceptable customer service. In other words, the dedicated site inspection mode allows the service providers to manage their expenditure for their areas while preventing these areas from producing unacceptable customer service.

In the user feedback data acquisition mode, the client terminal computer provides a pre-determined set of user feedback messages on the display device. The user feedback messages serve as service comments for selecting by users. Upon receiving a user input into the tactile input device, the client terminal computer issues a predetermined user feedback message over the client wireless communication module.

The pre-determined user feedback message is selected or is generated according to the user input. The client terminal computer is often equipped with a program for selecting the pre-determined user feedback message according to the user input, wherein the selection does not require manual intervention or input. Because of this, the issuing of the user feedback message can occur shortly after receiving the user input or feedback.

The Inspection server computer receives later the predetermined user feedback message from the client terminal computer over the server wireless communication module. The Inspection server computer then checks the received user feedback message as to whether the user feedback message indicates a user alert. The system enters into the alert mode, if the Inspection server computer identifies that the said user feedback message indicates a user alert.

In a generic sense, the Inspection server computer may receive other feedback messages beside the user alert. The Inspection server computer is usually equipped with a software program with corresponding data for differentiating the other feedback messages from the user alert.

In the alert mode, the Inspection server computer issues an alert message over the server wireless phone module to the mobile computing device. The server wireless phone module can include a 3G GMS network module or other communication network modules. The alert message is selected or is generated according to the user feedback message. The alert message acts for instructing a supervisor to proceed to the client terminal computer that has issued the respective user feedback message, which indicates a user alert.

Since the Inspection server computer can check the user feedback message electronically, the alert message can be issued quickly. This in turn allows the appropriate supervisor to be informed quickly of any service failure such that the service failure can be addressing soon. As one can see from this, this system allows for a fast response to a service failure.

In the inspection mode, the Inspection server computer selects one inspection data list from the set of inspection data lists. The inspection data list can be selected according to the user input.

The Inspection server computer then issues the selected inspection data list over the server wireless phone module to the appropriate mobile computing device. The inspection data list serves to instruct a supervisor to proceed to a particular location and to inspect a list of items shown in the inspection data list.

Upon arriving at the given location, the mobile computing device reads in pre-determined location information data that corresponds to the inspection data list from a device that is located at the said location. The reading of this pre-determined location information data serves to indicate that the supervisor is physically present at the said location.

The mobile computing device then receives site inspection data from the supervisor.

The supervisor inspects the site or location according to items shown in the inspection data list and provides data of site inspection. The supervisor also fixes or corrects any service failure that he has found during the site inspection.

The mobile computing device then issues a site data message containing the received location information data and the received site inspection data to the Inspection server computer. The Inspection server computer later receives the said site data message containing the location information data and the site inspection data.

The different modes of the system provide a structure for a quick service feedback and for a fast service inspection.

The application provides a system that is both economical and easy to use. By using a mobile computing device, such as a smart mobile phone, both for alerting a supervisor about an immediate and urgent customer complaint and for providing well-prepared site inspection lists, such an automated system is more easily accepted or received by users. Since most users are familiar with operating some forms of a mobile phone, these users would be able to easily adapt to the use of this said mobile computing device. This is especially so if the mobile computing device is also providing common telecommunication features, such as voice communication and SMS or MMS (Multimedia Messaging Service) data transmissions.

Optionally, the client terminal computer can also serve to provide the location information data. In the alert mode, the mobile computing device can read in a location information data at the particular client terminal computer that has issued the respective user feedback message, which indicates a user alert. The mobile computing device then issues a site data message containing the received location information data to the Inspection server computer. Later, the Inspection server computer receives the site data message containing the location information data. Rather than providing another device, this step uses the client terminal computer, which already exists, to provide the location information data

In addition, the client terminal computer can identify the mobile computing device that is communicating with the client terminal computer. In the alert mode, the client terminal computer can also receive unique phone identity data relating to the mobile computing device that has received the alert message. The phone identity data serves as mobile computing device identity data and it acts to identify the mobile computing device. The client terminal computer then issues a data message containing the received unique phone identity data to the Inspection server. The Inspection server computer later receives the site data message containing the unique phone identity data.

The Inspection server computer can store the received data for evaluation purposes or for data-mining purposes. The evaluation may reveal trends of service failure, which can be used for resource management. The Inspection server computer can also forward the stored received data to a reporting server computer for further evaluation purposes.

The mobile computing device can comprise a text data input device. The mobile computing device and the server wireless phone module each can comprise a GSM communication module. The GSM communication modules can provide GPRS, 3G, or 4G capabilities. Besides the GSM communication module, the client wireless communication module and the server wireless communication module each can also comprise a WLAN or other wireless communication module.

The alert message can also be sent in an SMS or a MMS format.

The client wireless communication module and the server wireless communication module each can comprise a GSM communication module. In a general sense, the client wireless communication module and the server wireless communication module each can also comprise a WLAN communication module or other wireless communication module.

Messages between the Inspection server computer and the client terminal computer can be transmitted in an SMS or a MMS format. All messages between communication modules can be sent as SMS or MMS messages or even as a simple push data packet, such as over FTP (File Transfer Protocol).

Data links between computers or servers can be provided as FTP data links for providing batch file operations. It is also possible to provide a direct data packet communication between applications on the various computers on any ISO level.

The inspection data list can comprise a checklist with blank data fields for receiving the site inspection data, wherein the site data message comprises the inspection data list and the site inspection data. The inspection data list provides a list of items for inspecting while the site inspection data provides a corresponding list of inspection results or information.

The mobile computing device can comprise a built-in camera being configured as a Bar code reader. The mobile computing device can also be used for transmitting photos to a superior data server, for instance for securing evidence, if a damage is detected.

The client terminal computer can comprise client memory unit for storing client data while the Inspection server computer can comprise client memory unit for storing server data. In the event of disruption of communication link between the client terminal computer and the Inspection server computer, these memory units can transfer their data to each other. These memory units then store and later transfer their data to each other after the communication link is established or restored. In other words, the memory units provide a means for the client terminal computer and the Inspection server computer to function until the communication link is restored.

The application also provides a client terminal computer with a display device, with one or more corresponding tactile input devices, with a client wireless communication module, and with a trigger port.

In particular, the tactile input device includes a touch screen, buttons, or tactile means that one must press or touch in order to provide an input. The client wireless communication module is intended for communication with a further computer device, which can be provided as an Inspection server computer or as a supervisor module server. The trigger port is used for receiving a trigger signal from a further electronic circuit.

In use, the client terminal computer provides a user feedback data acquisition mode and a wait mode.

In the wait mode, the client terminal computer is waiting for the trigger signal at the trigger port. Upon reception of a trigger signal, it changes into the user feedback data acquisition mode. The trigger signal serves to initiate the user feedback data acquisition mode.

In the user feedback data acquisition mode, the client terminal computer provides a pre-determined set of user feedback messages on the display device. The user feedback messages provide service comments for the user to select. Upon receiving a user input into the tactile input device, the client terminal computer issues a predetermined user feedback message over the client wireless communication module and it changes into the wait mode. The user feedback message is generated or is selected according to the user input and it serves to provide feedback about services received by the user.

After lapsing a pre-determined wait time without receiving a user input into the tactile input device, the client terminal computer can change from the user feedback data acquisition mode into the wait mode. The client terminal computer deems that the user does not wish to an input if no user input is received within the predetermined wait time. Changing into the wait mode then prevents other users, who are not the present actual user, from providing user input. In this manner, data integrity of the user input is preserved.

In the user feedback data acquisition mode, upon receiving a first user input into the tactile input device, the client terminal computer can provide a pre-determined second set of user feedback messages on the display device. The second set of user feedback messages can be selected according to the first user input. Upon receiving later a second user input into the tactile input device, the client terminal computer can change into the wait mode.

The structure provides two-level user service feedback, which allows for a detailed service feedback.

The application also provides a user feedback acquisition system. The system comprises the above client terminal computer and a motion sensor being electrically connected with a trigger port of the client terminal computer. When the motion sensor detects a user, the motion sensor actuates the trigger port of the client terminal computer to receive a service feedback from the user.

The application also provides a user feedback acquisition system. The system comprises the above client terminal computer and a purchase item bar code scanner being electrically connected with a trigger port of the client terminal computer. When the bar code scanner scans a purchase item, it also actuates the trigger port of the client terminal computer to receive a service feedback from the user.

The application also provides a user feedback acquisition system. The system comprises the above client terminal computer and a purchase item receipt printer being electrically connected with a trigger port of the client terminal computer. When the printer prints a receipt of a purchase, it also actuates the trigger port of the client terminal computer to receive a service feedback from the user.

The application also provides a user feedback acquisition system. The system comprises the above client terminal computer and a POS (point-of-sale) being connected electrically with a point-of-sale (POS) terminal device. The POS terminal device actuates the client terminal computer to receive a service feedback from a user.

The application provides a method for operating a facility management service. The method comprises a step of the facility management service providing a user feedback data acquisition service, an alert service, and a site inspection service,

Referring to the user feedback data acquisition service, it comprises a step of a client terminal computer providing a pre-determined set of user feedback messages on a display device. These feedback messages relates to service feedback or to service comments for selecting by a user.

Later, upon receiving a user input via a tactile input device of the client terminal computer relating to the feedback messages, the client terminal computer issues a pre-determined user feedback message to an Inspection server computer. The issued user feedback message is selected or is generated according to the user input.

The Inspection server computer later receives the transmitted pre-determined user feedback message from the client terminal computer over a server wireless communication module. The Inspection server computer then checks the user feedback message whether it indicates a user alert. The management service changes to provide the alert service, if the Inspection server computer identifies that the user feedback message indicates a user alert.

Referring to the alert service, it comprises a step of the Inspection server computer issuing an alert message over a server wireless phone module to a wireless mobile computing device. The alert message serves to instruct a supervisor to proceed to the client terminal computer that has issued the user feedback message, which indicates the user alert. The management service then changes to provide the inspection service.

Since a computer does the check of the user feedback message, the alert message can be selected or generated and be sent out quickly. This in turn allows for a quick response to any service failure.

Referring to the inspection service, it comprises a step of the Inspection server computer selecting one inspection data list from a set of inspection data lists and issuing the selected inspection data list over a communication module to the mobile computing device. The inspection data list can be selected according to the user input or to other means. The inspection data list serves to instruct the supervisor to proceed to a particular location and to perform site inspection according to items shown in the inspection data list.

Upon arriving at the location, the mobile computing device reads in a pre-determined location information data that corresponds to the inspection data list. This reading of the location information data acts to indicate or to confirm that the supervisor is present at the said location.

The mobile computing device later receives data of site inspection, which is performed by the supervisor according to the inspection data list. The supervisor also ofoften corrects or fixes any service failure detected the site inspection.

The mobile computing device then issues a site data message containing the received location information data and the received site inspection data to the Inspection server computer. The site data message serves as a report of the site inspection. The Inspection server computer afterward receives the transmitted site data message that contains the location information data and the site inspection data.

The inspection service can serve to initiate a site inspection of a particular location in which a user indicates the location has a service failure.

The management service then changes to provide the user feedback data acquisition service.

In a general sense, the inspection service can be initiated according a pre-determined inspection schedule while an immediate urgent inspection service can also be triggered by the alert service.

In summary, the method allows for a service feedback shortly after the service is provided to a user. It also allows for a fast generation of an alert in the event of a service failure.

The alert service can comprise the mobile computing device reading in a location information data at the client terminal computer that has issued the user feedback message, which indicates a user alert. The mobile computing device later issues a site data message containing the location information data to the Inspection server computer. After this, the Inspection server computer receives the site data message containing the location information data.

This step allows the location information data to be obtained from the client terminal computer, which already exists while without requiring additional infrastructure.

Alternatively, the alert service can also comprise a step of the client terminal computer receiving phone identity data relating to the mobile computing device that has received the alert message. The phone identity data acts as mobile computing device identity data. The client terminal computer afterward issues a data message containing the phone identity data to the Inspection server computer. Later, the Inspection server computer receives the data message containing the phone identity data.

This act enables the Inspection server computer to identify the mobile computing device from the phone identity data, which is included in to generate the site report.

The Inspection server computer often stores the received data for evaluation purposes or data-mining purposes. The Inspection server computer also often forwards the stored received data to a reporting server computer for further data-mining purposes.

The user feedback data acquisition service can comprise a step of the client terminal computer storing the predetermined user feedback message. The Inspection server computer receives the pre-determined user feedback message from the client terminal computer when a communication link between the client terminal computer and the Inspection server computer is established.

When the communication link between the client terminal computer and the Inspection server computer is disrupted, the client terminal sores the user feedback message and sends the user feedback message to the Inspection server computer when the communication link is resolved.

The application provides a method for operating a client terminal computer of a facility management service. The method comprises a step of the client terminal computer providing a user feedback data acquisition service and a wait service

Referring to the wait service, it comprises the client terminal computer waiting for a trigger signal at a trigger port of the client terminal computer. Upon reception of the trigger signal, the client terminal computer changes to provide the user feedback data acquisition service.

Referring to the user feedback data acquisition service, it comprises the client terminal computer providing a pre-determined set of user feedback messages on a display device. The feedback messages relate to service comments that are provided for a user to select.

Later, a user input relating to the feedback message is provided to a tactile input device of the client terminal computer. The client terminal computer then issues out a pre-determined user feedback message over a client wireless communication module to an Inspection server computer. The pre-determined user feedback message is selected or is generated according to the received user input. The client terminal computer afterward changes to provide the wait service.

This step allows collection of service feedback to be done immediately after the service is provided. In an event of service failure, the fast service feedback allows a quick response to the service failure.

Other means of generating the trigger signal are possible. In one implementation, a scanning of a purchase item generates the trigger signal. In another implementation, a printing of a sale receipt generates the trigger signal.

After lapsing a pre-determined wait time without receiving a user input into the tactile input device, the user feedback data acquisition service can comprise a step of the client terminal computer changing to provide the wait service.

The user feedback data acquisition service closes or ceases after the lapse of the wait time when no user input is received. The client terminal computer deems that the user does not wish to provide any service feedback when no user input is received within the wait time. Leaving the user feedback data acquisition service active after the wait time may allow other users, rather than the actual user, from providing service feedback.

Upon receiving a first user input into the tactile input device, the user feedback data acquisition service can also comprise a step of the client terminal computer providing a pre-determined second set of user feedback messages on the display device. The second set of user feedback messages can be generated or be selected according the first user input. Upon receiving a second user input into the tactile input device, the client terminal computer changes to provide the wait service.

This step provides a two level service feedback, which is able to provide a detailed service feedback. Although a two level feedback is described here, three or more levels of service feedback are also possible.

The embodiments can also be described with the following lists of features or elements being organized into items.

The respective combinations of features, which are disclosed in the item list, are regarded as independent subject matter, respectively, that can also be combined with other features of the application.
1. System for supporting facilities management services, the system comprising
   at least one client terminal computer comprising a display device, at least one corresponding tactile input device, and a client wireless communication module,
   an Inspection server computer comprising a server wireless communication module for communicating with the at least one client terminal computer, further comprising a server wireless phone module for communicating with at least one mobile computing device, and further comprising a pre-determined set of inspection data lists, and
   at least one mobile computing device,
      wherein the system provides a user feedback data acquisition mode, an alert mode, and a site inspection mode, wherein
         in the user feedback data acquisition mode,
   the client terminal computer provides a pre-determined set of user feedback messages on the display device, and upon receiving a user input into the tactile input device, the client terminal computer issuing a pre-determined user feedback message over the client wireless communication module,
   the Inspection server computer receives the predetermined user feedback message from the at least one client terminal computer over the server wireless communication module and checks the user feedback message whether it indicates a user alert, wherein the system enters into the alert mode, if the Inspection server computer identifies that the user feedback message indicates a user alert, in the alert mode, wherein
   the Inspection server computer issues an alert message over the server wireless phone module for instructing a supervisor to proceed to the at least one client terminal computer that has issued the respective user feedback message that indicates a user alert, and wherein
   in the inspection mode,
   the Inspection server computer selects one inspection data list from the set of inspection data lists and issues the inspection data list over the server wireless phone module,
   the mobile computing device reads in pre-determined location information data that corresponds to the inspection data list,
   the mobile computing device receives site inspection data,
   the mobile computing device issues a site data message containing the location information data and the site inspection data to the Inspection server computer, and
   the Inspection server computer receives the site data message containing the location information data and the site inspection data.
2. System according to item 1, wherein in the alert mode,
   the mobile computing device reads in a location information data at the least one client terminal computer that has issued the respective user feedback message that indicates a user alert,
   the mobile computing device issues a site data message containing the location information data,
   the Inspection server computer receives the site data message containing the location information data.
3. System according to item 1 or item 2, wherein in the alert mode,
   the at least one client terminal computer receives phone identity data relating to the mobile computing device that has received the alert message,
   the at least one client terminal computer issues a data message containing the phone identity data, and
   the Inspection server computer receives the data message containing the phone identity data.
4. System according to one of the aforementioned items, wherein
   the mobile computing device provides audio communication capabilities with other mobile computing devices.
5. System according to one of the aforementioned items, wherein
   the Inspection server computer stores the received data for evaluation purposes.
6. System according to item 5, wherein the Inspection server computer forwards the stored received data to a reporting server computer.
7. System according to one of the aforementioned items, wherein
   the mobile computing device comprises a text data input device.
8. System according to one of the aforementioned items, wherein
   the mobile computing device and the server wireless phone module each comprises a WLAN communication module.
9. System according to one of the aforementioned items, wherein
   the mobile computing device and the server wireless phone module each comprises a GSM communication module.
10. System according to one of the aforementioned items, wherein
   the alert message is sent in an SMS format.
11. System according to one of the aforementioned items, wherein
   the client wireless communication module and the server wireless communication module each comprises a WLAN communication module.
12. System according to one of the aforementioned items, wherein
   the client wireless communication module and the server wireless communication module each comprises a GSM communication module.
13. System according to one of the aforementioned items, wherein
   messages between the Inspection server computer and the at least one client terminal computer are trans-mitted in an SMS format.
14. System according to one of the aforementioned items, wherein
   the inspection data list comprises blank data fields for receiving the site inspection data, wherein the site data message comprises the inspection data list and the site inspection data.
15. System according to one of the aforementioned items, wherein
   the mobile computing device comprises a camera being configured as a Bar code reader.
16. System according to one of the aforementioned items, wherein
   the client terminal computer further comprising client memory unit for storing client data, the client data is provided for transmitting to the Inspection server computer and
   the Inspection server computer further comprising client memory unit for storing server data, the server data is provided for transmitting to the client terminal computer.
17. Client terminal computer with a display device and with at least one corresponding tactile input device and with a client wireless communication module for communication to a further computer device, and with a trigger port for receiving a trigger signal from a further electronic circuit,
   the client terminal computer further providing a user feedback data acquisition mode and a wait mode,
      wherein in the wait mode, the client terminal computer is waiting for a trigger signal at the trigger port, upon reception of a trigger signal, changing into the user feedback data acquisition mode,
      wherein in the user feedback data acquisition mode, the client terminal computer provides a predetermined set of user feedback messages on the display device, and upon receiving a user input into the tactile input device, the client terminal computer issues a pre-determined user feedback message over the client wireless communication module, and changing into the wait mode.
18. Client terminal computer according to item 17, wherein
   in the user feedback data acquisition mode, after lapsing a pre-determined wait time without receiving a user input into the tactile input device, the client terminal computer changing into the wait mode.
19. Client terminal computer according to item 18, wherein
   in the user feedback data acquisition mode, upon receiving a first user input into the tactile input device, the client terminal computer provides a predetermined second set of user feedback messages on the display device, and upon receiving a second user input into the tactile input device, changing into the wait mode.
20. User feedback acquisition system comprising
   a client terminal computer according to one of items 17 to 19, and
   a motion sensor being electrically connected with a trigger port of the client terminal computer.
21. User feedback acquisition system comprising
   a client terminal computer according to one of items 17 to 19, and
   a bar code scanner being electrically connected with a trigger port of the client terminal computer.
22. User feedback acquisition system comprising
   a client terminal computer according to one of items 17 to 19, and
   a receipt printer being electrically connected with a trigger port of the client terminal computer.
23. User feedback acquisition system comprising
   a client terminal computer according to one of items 17 to 19 and
   a point-of-sale (POS) being electrically connected with a point-of-sale (POS) terminal device.
24. Method for operating a management service, the method comprising
   the management service providing a user feedback data acquisition service, an alert service, and a site inspection service,
   wherein the user feedback data acquisition service comprises
   a client terminal computer providing a pre-determined set of user feedback messages, upon receiving a user input, the client terminal computer issues a pre-determined user feedback message, and
   an Inspection server computer receiving the predetermined user feedback message from the client terminal computer and checking the user feedback message whether it indicates a user alert, wherein the management service changes to provide the alert service, if the Inspection server computer identifies that the user feedback message indicates a user alert,
   wherein the alert service comprises
   the Inspection server computer issuing an alert message to a mobile computing device for instructing a supervisor to proceed to the client terminal computer that has issued the user feedback message that indicates the user alert and
   wherein the inspection service comprises
   the Inspection server computer selecting one inspection data list from a set of inspection data lists and issuing the inspection data list to the mobile computing device for instructing a supervisor,
   the mobile computing device reading in a predetermined location information data that corresponds to the inspection data list,
   the mobile computing device receiving site inspection data,
   the mobile computing device issuing a site data message containing the location information data and the site inspection data to the Inspection server computer, and
   the Inspection server computer receiving the site data message containing the location information dato and the site inspection data.
25. Method according to item 24,
   wherein the alert service further comprises
      the mobile computing device reading in a location information data at the client terminal computer that has issued the user feedback message that indicates a user alert,
      the mobile computing device issuing a site data message containing the location information data, and
      the Inspection server computer receiving the site data message containing the location information data.
26. Method according to item 24 or item 25, wherein the alert service further comprises
   the client terminal computer receiving phone identity data relating to the mobile computing device that has received the alert message,
   the client terminal computer issuing a data message containing the phone identity data, and
   the Inspection server computer receiving the data message containing the phone identity data.
27. Method according to one of items 24 to 26 further comprising
   the Inspection server computer storing the received data.
28. Method according to item 27 further comprising the Inspection server computer forwarding the stored received data to a reporting server computer.
29. Method according to one of items 24 to 28, wherein the user feedback data acquisition service further comprises
   the client terminal computer storing the predetermined user feedback message and
   the Inspection server computer receiving the predetermined user feedback message from the client terminal computer when a communication link between the client terminal computer and the Inspection server computer is established.
30. Method for operating a client terminal computer, the method comprising
   the client terminal computer providing a user feedback data acquisition service and a wait service, wherein the wait service comprises
      the client terminal computer waiting for a trigger signal, upon reception of a trigger signal, the client terminal computer changes to provide the user feedback data acquisition service,
   wherein the user feedback data acquisition service comprises
      the client terminal computer providing a predetermined set of user feedback messages on a display device, and upon receiving a user input, the client terminal computer issues out a pre-determined user feedback message, and the client terminal computer changes to provide the wait service.
31. Method according to item 30, wherein the trigger signal is provided by a scanning of a purchase item.
32. Method according to item 30 or 31, wherein the trigger signal is provided by a printing of a sale receipt of a purchase item.
33. Method according to one of items 30 to 32, wherein the user feedback data acquisition service further comprises,
   after lapsing a pre-determined wait time without receiving a user input, the client terminal computer changes to provide the wait service.
34. Method according to one of items 30 to 33, wherein the user feedback data acquisition service further comprises,
   upon receiving a first user input, the client terminal computer provides a pre-determined second set of user feedback messages on the display device, and upon receiving a second user input, the client terminal computer changing to provide the wait service.

Although the above description contains much specificity, this should not be construed as limiting the scope of the embodiments but merely providing illustration of the foreseeable embodiments. The above stated aspects of the embodiments should not be construed especially as limiting the scope of the embodiments but merely to explain possible achievements if the described embodiments are put into practice. Thus, the scope of the embodiments should be determined by the claims and their equivalents, rather than by the examples given.

### REFERENCE NUMBER

10 feedback management system
12 inspection server
13 front-end client computer
15 touch screen
17 antenna
18 RFID card reader
19 communication module
3G modem
21 communication module
22 antenna
23 communication module
24 smart phone
25 camera
28 computer
27 reporting server
29 computer
30 3G modem
35 supervisor module server
35′ supervisor module server
37 front-end client computer
39 supervisor screen
40 router
41 WLAN antenna
42 touch screen
43 POS terminal
45 screen icon
46 screen icon
50 alert
52 report
54 checklist
56 report
58 feedback management system
60 client computer
60′ client computer
62 RFID reader
65 state diagram
67 state
69 state
71 state
73 state
80 state diagram
82 state
83 state
85 state
87 state
88 integrated feedback management system
89 integrated feedback management system
90 server memory module
92 computer memory module

1. System for supporting facilities management services, the system comprising
at least one client terminal computer comprising a display device, at least one corresponding tactile input device, and a client wireless communication module,
an Inspection server computer comprising a server wireless communication module for communicating with the at least one client terminal computer, further comprising a server wireless phone module for communicating with at least one mobile computing device, and further comprising a predetermined set of inspection data lists, and
at least one mobile computing device, wherein the system provides a user feedback data acquisition mode, an alert mode, and a site inspection mode, such that
in the user feedback data acquisition mode,
the client terminal computer provides a predetermined set of user feedback messages on the display device, and upon receiving a user input into the tactile input device, the client terminal computer issuing a pre-determined user feedback message over the client wireless communication module,
the Inspection server computer receives the pre-determined user feedback message from the at least one client terminal computer over the server wireless communication module and checks the user feedback message whether it indicates a user alert, wherein the system enters into the alert mode, if the Inspection server computer identifies that the user feedback message indicates a user alert,
in the alert mode,
the Inspection server computer issues an alert message over the server wireless phone module for instructing a supervisor to proceed to the at least one client terminal computer that has issued the respective user feedback message that indicates a user alert, and
in the inspection mode, and
the Inspection server computer selects one inspection data list from the set of inspection data lists and issues the inspection data list over the server wireless phone module,
the mobile computing device reads in pre-determined location information data that corresponds to the inspection data list,
the mobile computing device receives site inspection data,
the mobile computing device issues a site data message containing the location information data and the site inspection data to the Inspection server computer, and
the Inspection server computer receives the site data message containing the location information data and the site inspection data.

2. System according to claim 1, wherein in the alert mode,
the mobile computing device reads in a location information data at the least one client terminal computer that has issued the respective user feedback message that indicates a user alert,
the mobile computing device issues a site data message containing the location information data, and
the Inspection server computer receives the site data message containing the location information data.

3. System according to claim 1, wherein in the alert mode,
the at least one client terminal computer receives phone identity data relating to the mobile computing device that has received the alert message,
the at least one client terminal computer issues a data message containing the phone identity data, and
the Inspection server computer receives the dato message containing the phone identity data.

4. System according to claim 1, wherein
the mobile computing device provides audio communication capabilities with other mobile computing devices.

5. System according to claim 1, wherein
the Inspection server computer stores the received data for evaluation purposes.

6. System according to claim 5, wherein
the Inspection server computer forwards the stored received data to a reporting server computer.

7. System according to claim 1, wherein
the mobile computing device comprises a text data input device.

8. System according to claim 1, wherein
the mobile computing device and the server wireless phone module each comprises a WLAN communication module.

9. System according to claim 1, wherein
the mobile computing device and the server wireless phone module each comprises a GSM communication module.

10. System according to claim 1, wherein
the alert message is sent in an SMS format.

11. System according to claim 1, wherein
the client wireless communication module and the server wireless communication module each comprises a WLAN communication module.

12. System according to claim 1, wherein
the client wireless communication module and the server wireless communication module each comprises a GSM communication module.

13. System according to claim 1, wherein
messages between the Inspection server computer and the at least one client terminal computer are transmitted in an SMS format.

14. System according to claim 1, wherein
the inspection data list comprises blank data fields for receiving the site inspection data, wherein the site data message comprises the inspection data list and the site inspection data.

15. System according to claim 1, wherein
the mobile computing device comprises a camera being configured as a Bar code reader.

16. System according to claim 1, wherein
the client terminal computer further comprising client memory unit for storing client data, the client data is provided for transmitting to the Inspection server computer and
the Inspection server computer further comprising client memory unit for storing server data, the server data is provided for transmitting to the client terminal computer.

17. Client terminal computer with a display device and with at least one corresponding tactile input device and with a client wireless communication module for communication to a further computer device, and with a trigger port for receiving a trigger signal from a further electronic circuit,
the client terminal computer further providing a user feedback data acquisition mode and a wait mode,
wherein in the wait mode,
the client terminal computer is waiting for a trigger signal at the trigger port, upon reception of a trigger signal, changing into the user feedback data acquisition mode,
wherein in the user feedback data acquisition mode,
the client terminal computer provides a predetermined set of user feedback messages on the display device, and upon receiving a user input into the tactile input device, the client terminal computer issues a pre-determined user feedback message over the client wireless communication module, and changing into the wait mode.

18. Client terminal computer according to claim 17, wherein
in the user feedback data acquisition mode,
after lapsing a pre-determined wait time without receiving a user input into the tactile input device, the client terminal computer changing into the wait mode.

19. Client terminal computer according to claim 18, wherein
in the user feedback data acquisition mode, upon receiving a first user input into the tactile input device, the client terminal computer provides a predetermined second set of user feedback messages on the display device, and upon receiving a second user input into the tactile input device, changing into the wait mode.

20. User feedback acquisition system comprising
a client terminal computer according to claim 17, and
a motion sensor being electrically connected with a trigger port of the client terminal computer.

21. User feedback acquisition system comprising
a client terminal computer according to claim 17, and
a bar code scanner being electrically connected with a trigger port of the client terminal computer.

22. User feedback acquisition system comprising
a client terminal computer according to claim 17, and
a receipt printer being electrically connected with a trigger port of the client terminal computer.

23. User feedback acquisition system comprising
a client terminal computer according to claim 17 and
a point-of-sale (POS) being electrically connected with a point-of-sale (POS) terminal device.

24. Method for operating a management service, the method comprising
the management service providing a user feedback data acquisition service, an alert service, and a site inspection service,
wherein the user feedback data acquisition service comprises
a client terminal computer providing a predetermined set of user feedback messages, upon receiving a user input, the client terminal computer issues a pre-determined user feedback message, and
an Inspection server computer receiving the pre-determined user feedback message from the client terminal computer and checking the user feedback message whether it indicates a user alert, wherein the management service changes to provide the alert service, if the Inspection server computer identifies that the user feedback message indicates a user alert,
wherein the alert service comprises
the Inspection server computer issuing an alert message to a mobile computing device for instrutting a supervisor to proceed to the client terminal computer that has issued the user feedback message that indicates the user alert, and
wherein the inspection service comprises
the Inspection server computer selecting one inspection data list from a set of inspection data lists and issuing the inspection data list to the mobile computing device for instructing a supervisor,
the mobile computing device reading in a predetermined location information data that corresponds to the inspection data list,
the mobile computing device receiving site inspection data,
the mobile computing device issuing a site data message containing the location information data and the site inspection data to the Inspection server computer, and
the Inspection server computer receiving the site data message containing the location information data and the site inspection data.

25. Method according to claim 24,
wherein the alert service further comprises
the mobile computing device reading in a location information data at the client terminal computer that has issued the user feedback message that indicates a user alert,
the mobile computing device issuing a site data message containing the location information data, and
the Inspection server computer receiving the site data message containing the location information data.

26. Method according to claim 24, wherein
the alert service further comprises
the client terminal computer receiving phone identity data relating to the mobile computing device that has received the alert message,
the client terminal computer issuing a data message containing the phone identity data, and
the Inspection server computer receiving the data message containing the phone identity data.

27. Method according to claim 24 further comprising
the Inspection server computer storing the received data.

28. Method according to claim 27 further comprising
the Inspection server computer forwarding the stored received data to a reporting server computer.

29. Method according to claim 24, wherein
the user feedback data acquisition service further comprises
the client terminal computer storing the predetermined user feedback message and
the Inspection server computer receiving the pre-determined user feedback message from the client terminal computer when a communication link between the client terminal computer and the Inspection server computer is established.

30. Method for operating a client terminal computer, the method comprising
the client terminal computer providing a user feedback data acquisition service and a wait service,
wherein the wait service comprises
the client terminal computer waiting for a trigger signal, upon reception of a trigger signal, the client terminal computer changes to provide the user feedback data acquisition service,
wherein the user feedback data acquisition service comprises
the client terminal computer providing a predetermined set of user feedback messages on a display device, and upon receiving a user input, the client terminal computer issues out a predetermined user feedback message, and the client terminal computer changes to provide the wait service.

31. Method according to claim 30, wherein
the trigger signal is provided by a scanning of a purchase item.

32. Method according to claim 30, wherein
the trigger signal is provided by a printing of a sale receipt of a purchase item.

33. Method according to claim 30, wherein
the user feedback data acquisition service further comprises,
after lapsing a pre-determined wait time without receiving a user input, the client terminal computer changes to provide the wait service.

34. Method according to claim 30, wherein
the user feedback data acquisition service further comprises,
upon receiving a first user input, the client terminal computer provides a pre-determined second set of user feedback messages on the display device, and upon receiving a second user input, the client terminal computer changing to provide the wait service.
